(19) United States
(12) Patent Application Publication
(10) Pub. No.: US 2008/0054049 A1
(43) Pub. Date: Mar. 6, 2008

(54) Mold and method for making a trim component

(75) Inventors: Glenn A. Cowelchuk, Chesterfield Tw., MI (US); David Turczynski, Highland, MI (US); David J. Dooley, Troy, MI (US); Robert J. Adams, Ypsilanti, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/582,671

(22) Filed: Oct. 18, 2006

Related U.S. Application Data
(63) Continuation-in-part of application No. 11/514,641, filed on Sep. 1, 2006.

(51) Int. Cl. A47J 36/02

(52) U.S. Cl. 228/101

(57) ABSTRACT

A method of forming a vehicle trim component includes providing a first component layer having a vent aperture formed therethrough. A second component layer is then formed adjacent a surface of the first component layer, wherein gas may flow through the vent aperture of the first component layer during the step of forming the second component layer.

### CROSS REFERENCE TO RELATED APPLICATIONS

This application is a Continuation-in-Part of U.S. patent application Ser. No. 11/514,641, filed Sep. 1, 2006, and entitled MOLD AND METHOD FOR MAKING A TRIM COMPONENT, which is incorporated in the present application in its entirety.

Inventors: Glenn A. Cowelchuk, David J. Dooley, David Turczynski, and Robert J. Adams.

### BACKGROUND

Various embodiments of a mold assembly for forming a trim component are described herein. In particular, the embodiments described herein relate to an improved mold assembly for forming a trim component for a vehicle, and an improved method of manufacturing such a trim component.

It is often necessary to vent the air out of the article defining cavity of a plastic injection mold, however attempts to vent the cavity are often expensive and/or complex.

In conventional two-shot molding operations, a first open mold cavity is defined between contoured surfaces of a core mold part and a second mold part facing each other. A first material is injected in the first open mold cavity to form a first molded layer. The second mold part is replaced with a third mold part. A second open mold cavity is defined between the contoured surfaces of the third mold part and a surface of the first molded layer. A second material is then injected in the second open mold cavity to form a second molded layer.

In such conventional molding operations, gasses may become trapped within the mold cavities during the injection of the materials. When molding relatively small parts or objects, the presence of small amounts of gasses may not have an undesirable effect on the object. In relatively large objects however, gasses that are trapped within the mold cavities during the injection of the materials must be vented out of the mold cavities to avoid undesirable deformation of the objects. Conventional gas vents may be located at the parting lines of the mold parts but may cause undesirable melting of the molded object near the gas vent, and may produce undesirable flashing at an A-side surface of the fished part. It would therefore be desirable to provide an improved mold assembly for forming a trim component.

U.S. Pat. No. 6,422,850 discloses the use of a valve assembly including a vent pin for use in venting gasses from a mold cavity in a single shot molding operation. A previously molded core is first placed into the cavity. The vent pin is in an open position during the flow of resin into the cavity. Just prior to completion of the resin flow, the vent pin is moved to an extended position, thereby closing the vent. The end of the vent pin defines, and leaves a visible mark on, a portion of the formed A-side surface of the cover layer.

U.S. Pat. No. 6,042,361 discloses a mold for use in a plastic injection molding system which includes a venting pin assembly. The venting pin assembly can eject a formed article from the mold and includes a porous insert to permit the flow of air from the article forming cavity. An end surface of the venting pin and the porous insert is positioned flush within the mold such that it defines a portion of the A-surface of the article formed in the mold.

### SUMMARY

The present application describes various embodiments of a mold assembly for forming a trim component and various embodiments of a method of manufacturing such a trim component. One embodiment of a method of manufacturing a vehicle trim component includes providing a first component layer having a vent aperture formed therethrough. A second component layer is then formed adjacent a surface of the first component layer, wherein gas may flow through the vent aperture of the first component layer during the step of forming the second component layer.

Another embodiment of the method of manufacturing a vehicle trim component includes forming the first component layer within a mold assembly, and forming the vent aperture about a pin mounted to a portion of the mold assembly during the step of forming a first component layer within a mold assembly.

In another embodiment of the method of manufacturing a vehicle trim component, the pin is moveably mounted to a portion of the mold assembly.

In another embodiment of the method of manufacturing a vehicle trim component, the pin is formed from a porous material.

Other advantages of the of the mold assembly for forming a trim component and the method of manufacturing the trim component will become apparent to those skilled in the art from the following detailed description, when read in light of the accompanying drawings.

### BRIEF DESCRIPTION OF THE DRAWINGS

FIG. 1 is a schematic elevational view in section of a portion of an embodiment of a trim component.

FIG. 2 is a cross sectional view of a first embodiment of a mold assembly showing the mold assembly in the first mold assembly position and the vent pin in the first pin position.

FIG. 3 is a cross sectional view of the mold assembly illustrated in FIG. 2, showing the mold assembly in the second mold assembly position.

FIG. 4 is a cross sectional view of the mold assembly illustrated in FIG. 3, showing the vent pin in the second pin position.

FIG. 5 is a cross sectional view of a second embodiment of a mold assembly showing the mold assembly in the first mold assembly position.

FIG. 6 is a cross sectional view of the mold assembly illustrated in FIG. 5, showing the mold assembly in the second mold assembly position.

FIG. 7 is a cross sectional view of a third embodiment of a mold assembly showing the mold assembly in the first mold assembly position.

FIG. 8 is a cross sectional view of the mold assembly illustrated in FIG. 7, showing the mold assembly in the second mold assembly position.

### DETAILED DESCRIPTION OF THE INVENTION

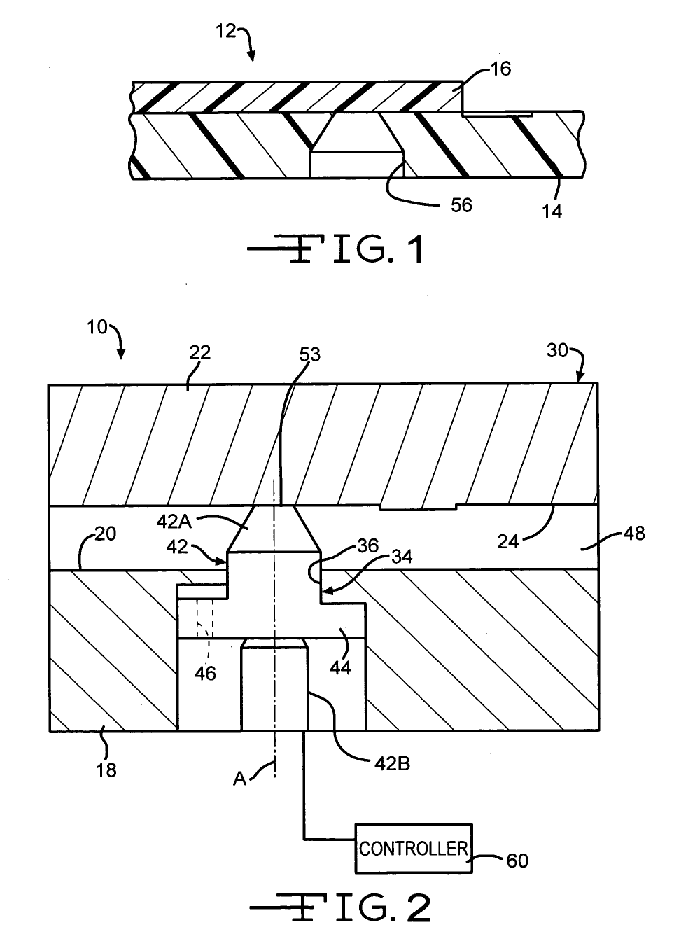

Referring now to the drawings, there is illustrated in FIGS. 2 through 4, inclusive, a first embodiment of a mold assembly for forming a trim component is indicated generally at 10. In the exemplary embodiment illustrated, the mold assembly 10 is used in a two-shot molding process to produce a trim component 12, such as an automotive trim panel, a portion of which is shown in cross section in FIG. 1. The illustrated trim component 12 includes first and second molded component layers, 14 and 16, respectively, as will be described in detail below. It will be appreciated however, that the various embodiments of the mold assembly 10 disclosed and described herein, may be used to form any desired trim component or trim panel, such as a vehicle door panel, a vehicle instrument panel, and the like.

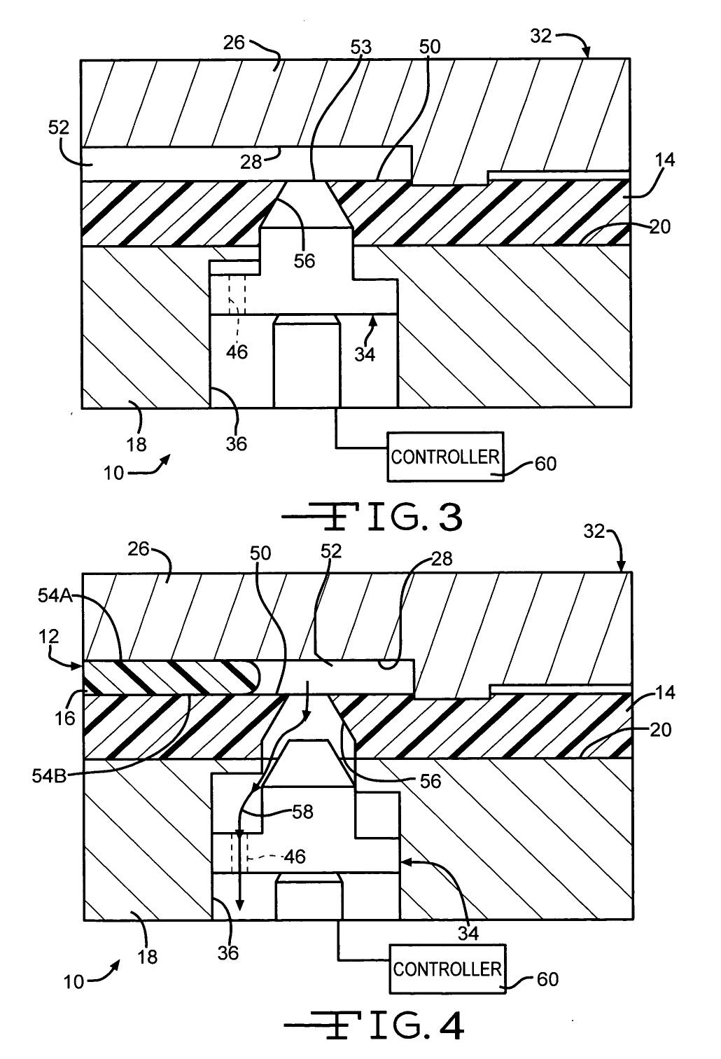

The mold assembly 10 illustrated in FIGS. 2 through 4 includes a first mold portion 18 defining a first contour surface 20, as shown in FIGS. 2 through 4, a second mold portion 22 defining a second contour surface 24, as shown in FIG. 2, and a third mold portion 26 defining a third contour surface 28, as shown in FIGS. 3 and 4.

In the first embodiment illustrated in FIG. 2, a combination of the first mold portion 18 and the second mold portion 22 defines a first mold assembly position 30 of the mold assembly 10. In the embodiment illustrated in FIGS. 3 and 4, a combination of the third mold portion 26 and the first mold portion 18 defines a second mold assembly position 32 of the mold assembly 10. The illustrated mold assembly 10 is moveable between the first mold assembly position 30 and the second mold assembly position 32, as will be described in detail herein below.

Referring to FIG. 2, the mold assembly 10 is illustrated in the first mold assembly position 30. The first mold portion 18 includes a vent pin 34 moveably mounted within a first vent aperture 36 formed in the first contour surface 20 of the first mold portion 18 along a movement axis A. The illustrated vent pin 34 includes a substantially cylindrical body 42 having a first end portion 42A (upper end as viewed in FIG. 2), a shaft portion 42B, and a radially extending flange 44 between the first end portion 42A and the shaft portion 42B. A vent passage 46 may be formed through the flange 44. In the illustrated embodiment, the first end portion 42A of the body 42 has the shape of a frustum of a cone. Alternatively, the first end portion 42A may be substantially cylindrical, or may have any other desired shape. The body 42 may also have any other desired shape. Although only one vent pin 34 is illustrated, it will be understood that the mold assembly 10 may include any desired number of vent pins 34.

In one embodiment of the vent pin 34, the vent pin 34 (and therefore the second vent aperture 56, which will be described in detail below) has a diameter within the range of from about 0.060 inch to about 0.375 inch. In another embodiment of the vent-forming pin 134, the vent-forming pin 134 has a diameter within the range of from about 0.080 inch to about 0.125 inch. It will be understood however, that the vent pin 34 may be any other desired diameter or have any other desired transverse sectional size.

When in the first mold assembly position 30, the first contour surface 20 and the second contour surface 24 define a first cavity 48 for receiving a first material which forms the first component layer 14 (shown in the cavity 48 in FIGS. 3 and 4) of the trim component 12.

Referring to FIGS. 3 and 4, the mold assembly 10 is illustrated in the second mold assembly position 32. When in the second mold assembly position 32, the third contour surface 28 and a surface 50 of the first component layer 14 define a second cavity 52 for receiving a second material which forms the second component layer 16 (shown partially filling the cavity 52 in FIG. 4) of the trim component 12.

The vent pin 34 is moveable along the axis A between a first pin position and a second pin position. In the first pin position, the first vent aperture 36 is blocked and a first end surface 53 (upper end surface as viewed in FIG. 2) of the vent pin 34 engages the second contour surface 24, as shown in FIG. 2. Alternatively, in the first pin position, the first vent aperture 36 is blocked and the first end surface 53 of the vent pin 34 is substantially coplanar with the surface 50 of the first component layer 14, as shown in FIG. 3. Although not illustrated, after the second material is completely introduced into the second cavity 52 to form the second component layer 16 (as shown in FIG. 4), the end surface 53 of the vent pin 34 returns to the first pin position and engages a surface 54B (lower surface as viewed in FIG. 4) of the second component layer 16.

In the embodiment shown in FIGS. 3 and 4, the vent pin 34 forms a second vent aperture 56 in the first component layer 14. When the vent pin 34 is in the second pin position, as shown in FIG. 4, the first vent aperture 36 and the second vent aperture 56 are open and define a fluid or gas outlet for the outward flow, as indicated by the arrow 58, of one or more gasses trapped within the second cavity 52 during the introduction of the second material.

In one embodiment of the mold process described herein, the trim component 12 is manufactured using a two-shot molding process, as schematically illustrated in FIGS. 2 through 4. The two-shot molding process may be accomplished by moving or rotating the first mold portion 18, such as in a rotational molding process. In such a rotational molding process, the first component layer 14 (comprised of the first material) is first injection molded in the first mold assembly position 30 of the mold assembly 10, as described herein. The first mold portion 18 containing the first component layer 14 may be then rotated to a second position wherein the first mold portion 18 is joined with the third mold portion 26 to define the second mold assembly position 32 and the second cavity 52. The second component layer 16 (comprised of the second material) is then injection molded in the second cavity 52.

In an alternate embodiment of the mold process, two separate molds could be used sequentially to form the first component layer 14 and the second component layer 16. It will be understood that the trim component 12 may be manufactured by any desired two step molding process.

In another alternate embodiment of the mold process, the first mold portion 18 and the second mold portion 22 may be combined to define the second cavity. For example, after forming the first component layer 14, the second mold portion 22 may be moved outwardly (upwardly as viewed in FIG. 2) of the first mold portion 18 to define the second cavity, thereby eliminating the need for the third mold portion 26.

It will be understood that the one or more first vent apertures 36, and the corresponding vent pins 34 moveably mounted therein, may be located at any desired location in the first contour surface 20 of the first mold portion 18. In one embodiment, the one or more first vent apertures 36 and vent pins 34 are located in the first contour surface 20 near an end-of-fill location of the first material. As used herein, the end-of-fill location is defined as the region within a mold cavity, such as the second cavity 52, that is last filled by a material, such as the second material.

The location or position of such an end-of-fill location within a mold cavity may vary from mold assembly to mold assembly, depending on the size, shape, and contour of the mold cavity. It will therefore be understood that some experimentation may be required to determine the end-of-fill location for a mold assembly, and to therefore determine the most advantageous location or position of the one or more first vent apertures 36 and corresponding vent pins 34. Alternatively, the one or more first vent apertures 36 and vent pins 34 may be located at any other desired location in the first contour surface 20 of the first mold portion 18.

In one embodiment of the method of manufacturing the trim component 12, the vent pin 34 will be moved from the second pin position to the first pin position just prior to the second material reaching the end-of-fill location, and therefore the location of the first and second vent apertures 36 and 56. The movement of the vent pin 34 may be controlled by any desired means. For example, the mold assembly 10 may include a controller 60, illustrated schematically in FIGS. 2 through 4, for controlling the movement of the vent pin 34.

In one embodiment of the mold assembly 10, the controller receives a signal from a screw position sensor (not shown). In another embodiment of the mold assembly 10, the controller receives a signal from a timer (not shown). In another embodiment of the mold assembly 10, the controller receives a signal from a gauge (not shown) for measuring pressure within the first and/or second cavities 48 and 52.

The first material of the first component layer 14 may be any desired substantially rigid material, such as a polymer or plastic. Examples of materials suitable for the first component layer 14 include polypropylene, thermoplastic elastomer (TPE), thermoplastic elastomer polyolefin, polycarbonate, acrylonitrile butadiene styrene (ABS), polycarbonate ABS, styrene maleic anhydride (SMA), polyphenylene oxide (PPO), nylon, polyester, acrylic, and polysulfone. It will be understood that the A-side surface 50A of the first component layer 14 may have any desired texture and color.

The second material of the second component layer 16 may also include polypropylene, TPE, thermoplastic elastomer polyolefin, polycarbonate, ABS, polycarbonate ABS, SMA, PPO, nylon, polyester, acrylic, and polysulfone. Additionally, other materials such as thermoplastic elastomer-ether-ester (TEEE), ethylene propylene diene monomer (EPDM), and any other desired material, such as other elastomers and non-elastomers, may be used. It will be understood that an A-side surface 54A, as shown in FIG. 4, of the second component layer 16 may have any desired texture and color.

The mold assembly 10 for forming the trim component 12, as described herein, is advantageous over prior art designs. The mold assembly 10 is advantageous because the gas or gasses that may be present during the introduction of material, such as the second material, into a mold cavity, such as the second cavity 52, may flow efficiently and safely out of the second cavity 52 during the injection molding process. The outward flow of gas from the second cavity 52 may be accomplished without the undesirable melting of the molded object near conventional gas vent or vents, or the production of undesirable flashing at an A-side surface of the fished part.

It will be understood that the vent pin 34 may also be moved to the second pin position such that the first vent aperture 36 is open during the introduction of the first material into the first cavity 48, and then moved to the first pin position just prior to the first material reaching the end-of-fill location of the first cavity 48, as described in detail herein above.

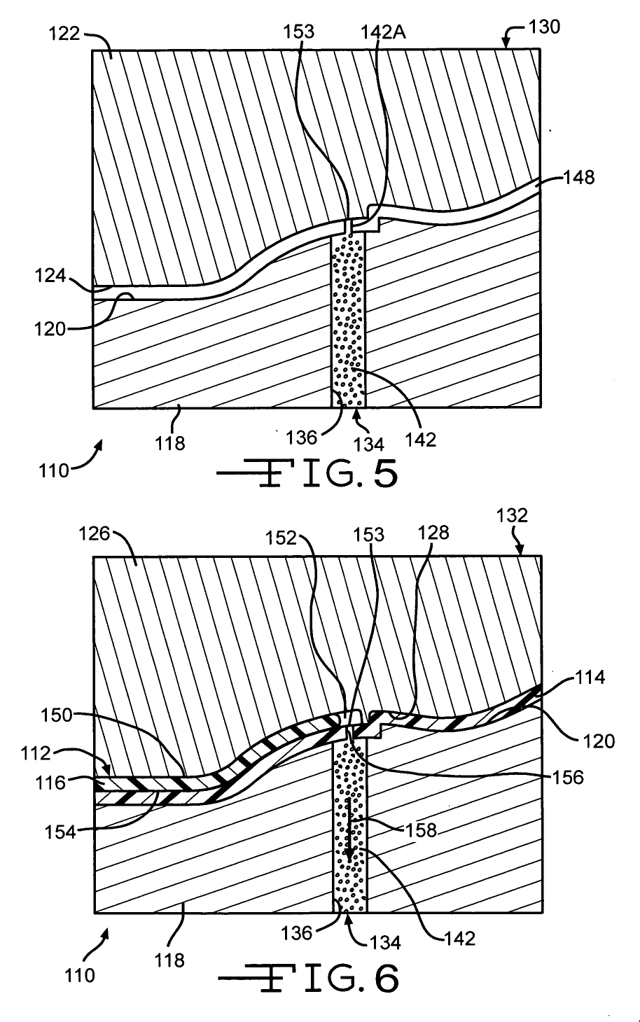

Referring now to FIGS. 5 and 6, and using like reference numbers to indicate corresponding parts, a second embodiment of a mold assembly for forming a trim component 112 is indicated generally at 110. As shown therein, the mold assembly 110 includes a first mold portion 118 defining a first contour surface 120, as shown in FIGS. 5 and 6, a second mold portion 122 defining a second contour surface 124, as shown in FIG. 5, and a third mold portion 126 defining a third contour surface 128, as shown in FIG. 6.

In the second embodiment of the mold assembly 110 illustrated in FIG. 5, a combination of the first mold portion 118 and the second mold portion 122 defines the first mold assembly position 130 of the mold assembly 110. In the embodiment illustrated in FIG. 6, a combination of the third mold portion 126 and the first mold portion 118 defines a second mold assembly position 132 of the mold assembly 110. The illustrated mold assembly 110 is moveable between the first mold assembly position 130 and the second mold assembly position 132, as described in detail herein.

Referring to FIG. 5, the mold assembly 110 is illustrated in the first mold assembly position 130. The first mold portion 118 includes a porous vent pin 134 mounted within a first vent aperture 136 formed in the first contour surface 120 of the first mold portion 18. The illustrated vent pin 134 includes a body 142 having a first end portion 142A (upper end as viewed in FIG. 5). In the illustrated embodiment, the first end portion 142A of the body 142 is substantially cylindrical and has a diameter less than a diameter or width of the body 142. Alternatively, the first end portion 142A may have any other desired shape. Although only one vent pin 134 is illustrated, it will be understood that the mold assembly 110 may include any desired number of vent pins 134.

In one embodiment of the vent pin 134, the vent pin 134 (and therefore the second vent aperture 156, which will be described in detail below) has a diameter within the range of from about 0.060 inch to about 0.375 inch. In another embodiment of the vent-forming pin 134, the vent-forming pin 134 has a diameter within the range of from about 0.080 inch to about 0.125 inch. It will be understood however, that the vent pin 134 may be any other desired diameter or have any other desired transverse sectional size.

The porous vent pin 134 may be formed from any desired porous material. In one embodiment, the vent pin 134 is formed from a material having a porosity within the range of from about 20 percent to about 30 percent. In another embodiment, the vent pin 134 is formed from porous steel. In another embodiment, the vent pin 134 is formed from Porcerax II®. It will be understood that the vent pin 134 may be formed from any other porous metal, metal alloy, or non-metal material.

When in the first mold assembly position 130, the first contour surface 120 and the second contour surface 124 define a first cavity 148 for receiving the first material which forms the first component layer 114 of the trim component 112.

Referring to FIG. 6 the mold assembly 110 is illustrated in the second mold assembly position 132. When in the second mold assembly position 132, the third contour surface 128 and a surface 150 of the first component layer 114 of the trim component 112 define a second cavity 152 for receiving the second material which forms the second component layer 116 of the trim component 112.

In the illustrated embodiment, a first end surface 153 (upper end surface as viewed in FIG. 5) of the vent pin 134 engages the second contour surface 124, as shown in FIG. 5. Although not illustrated, after the second material is completely introduced into the second cavity 152 to form the second component layer 116 of the trim component 112 (as shown in FIG. 6), the end surface 153 of the vent pin 134 also engages a surface 154 of the second component layer 116.

In the embodiment shown in FIG. 6, the vent pin 134 forms a second vent aperture 156 in the first component layer 114. The vent pin 134 defines a gas outlet for the outward flow, as indicated by the arrow 158, of one or more gasses trapped within the first and/or second cavities 148 and 152, during the introduction of the first and/or second materials, respectively.

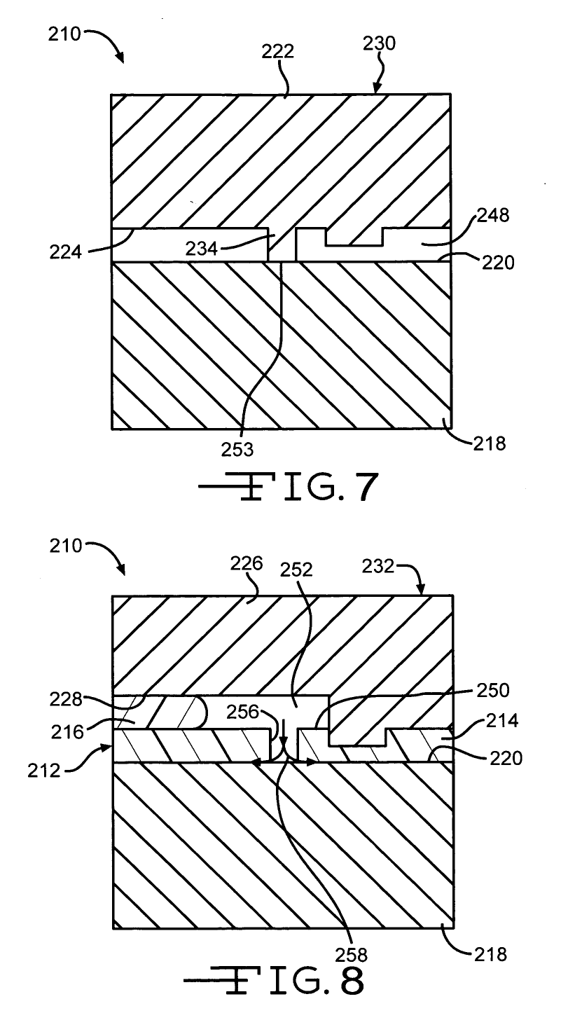

Referring now to FIGS. 7 and 8, and using like reference numbers to indicate corresponding parts, a third embodiment of a mold assembly for forming a trim component 212, best shown in FIG. 8, is indicated generally at 210. As shown therein, the mold assembly 210 includes a first mold portion 218 defining a first contour surface 220, as shown in FIGS. 7 and 8, a second mold portion 222 defining a second contour surface 224, as shown in FIG. 7, and a third mold portion 226 defining a third contour surface 228, as shown in FIG. 8.

A vent-forming pin 234 extends outwardly (downwardly as viewed in FIG. 7) of the second contour surface 224. The illustrated vent-forming pin 234 is substantially cylindrical in shape. Alternatively, the vent-forming pin 234 may have any other desired shape. Although only one vent-forming pin 234 is illustrated, it will be understood that the mold assembly 210 may include any desired number of vent-forming pins 234.

In one embodiment of the vent-forming pin 234, the vent-forming pin 234 (and therefore the second vent aperture 256, which will be described in detail below) has a diameter within the range of from about 0.060 inch to about 0.375 inch. In another embodiment of the vent-forming pin 234, the vent-forming pin 234 has a diameter within the range of from about 0.080 inch to about 0.125 inch. It will be understood however, that the vent pin 234 may be any other desired diameter or have any other desired transverse sectional size.

In the third embodiment of the mold assembly 210 illustrated in FIG. 7, a combination of the first mold portion 218 and the second mold portion 222 defines the first mold assembly position 230 of the mold assembly 210. In the embodiment illustrated in FIG. 8, a combination of the third mold portion 226 and the first mold portion 218 defines a second mold assembly position 232 of the mold assembly 210. The illustrated mold assembly 210 is moveable between the first mold assembly position 230 and the second mold assembly position 232, as described in detail herein.

Referring to FIG. 7, the mold assembly 210 is illustrated in the first mold assembly position 230. When in the first mold assembly position 230, the first contour surface 220 and the second contour surface 224 define a first cavity 248 for receiving the first material which forms the first component layer 214, best shown in FIG. 8, of the trim component 212.

Referring to FIG. 8 the mold assembly 210 is illustrated in the second mold assembly position 232. When in the second mold assembly position 232, the third contour surface 228 and a surface 250 of the first component layer 214 of the trim component 212 define a second cavity 252 for receiving the second material which forms the second component layer 216 (shown partially filling the cavity 252 in FIG. 84) of the trim component 212.

In the illustrated embodiment, an end surface 253 (lower end surface as viewed in FIG. 7) of the vent-forming pin 234 engages the first contour surface 220, as shown in FIG. 7.

As best shown in FIG. 8, the vent-forming pin 234 forms a vent aperture 256 in the first component layer 214. The vent aperture 256 defines a gas outlet for the outward flow, as indicated by the arrows 258, of one or more gasses trapped within the second cavity 252, during the introduction of the second material.

As has been observed, injection molded components, such as the first component layer 214, may shrink slightly within a mold during cooling. Advantageously, the gasses within the second cavity 252 may flow outwardly through the vent aperture 256 and further flow or seep (as shown by the arrow 258) into a very small gap or space (not shown) defined between the cooled first component layer 214 and the first contour surface 220. The need for a vent aperture in the first mold portion 218 is thereby eliminated.

The principle and mode of operation of the mold assembly for forming a trim component and the method of manufacturing such a trim component have been described in its various embodiments. However, it should be noted that the mold assembly and method of manufacturing a trim component described herein may be practiced otherwise than as specifically illustrated and described without departing from its scope.

What is claimed is:

1. A method of forming a vehicle trim component, the method comprising the steps of:
a. providing a first component layer having a vent aperture formed therethrough; and
b. forming a second component layer adjacent a surface of the first component layer, wherein gas may flow through the vent aperture of the first component layer during the step of forming the second component layer.

2. The method according to claim 1, further including the step of:
c. closing the vent aperture of the first component layer after the step of forming the second component layer has begun.

3. The method according to claim 1, wherein the step of providing a first component layer includes forming the first component layer within a mold assembly, the method further including the step of:
c. venting gas flowing through the vent aperture of the first component layer during the step of forming the second component layer.

4. The method according to claim 3, wherein step (c) further includes venting gas through a mold assembly vent aperture formed in the mold assembly.

5. The method according to claim 3, wherein during the step of forming a first component layer within a mold assembly, the vent aperture is formed about a pin mounted to a portion of the mold assembly.

6. The method according to claim 5, wherein the pin is formed from a porous material such that gas may flow through the pin during the step of forming a first component layer and the step of forming a second component layer.

7. The method according to claim 5, wherein the pin is moveably mounted to a portion of the mold assembly.

8. A mold assembly for forming a trim component having a first layer and a second layer, said mold assembly comprising:
a first mold portion defining a first contour surface;
a second mold portion defining a second contour surface, said first contour surface and said second contour surface defining a first cavity for receiving a first material, said first material forming a first layer of a trim component, a surface of said first layer of said trim component and said second contour surface defining a second cavity for forming a second layer of said trim component; and
a vent pin moveably mounted within a first vent aperture in said first contour surface of said first mold portion, said vent pin moveable between a first pin position and a second pin position;
wherein in said first pin position said first vent aperture is blocked and said vent pin engages said second contour surface, said vent pin defining a second vent aperture in said first layer; and
wherein in said second pin position said first vent aperture and said second vent aperture are open and define an outlet for gasses from said second cavity.

9. The mold assembly according to claim 8, further including a third mold portion defining a third contour surface, said surface of said first layer of said trim component and said third contour surface defining said second cavity.

10. The mold assembly according to claim 8, including a controller, said controller controlling movement of said vent pin between said first and said second pin positions.

11. The mold assembly according to claim 10, wherein said controller receives a signal from one of a screw position sensor, a timer, and a pressure gauge within said second cavity.

12. The mold assembly according to claim 8, wherein said first and second vent apertures define an outlet for gas present in said second cavity during forming of said second layer of said trim component.

13. The mold assembly according to claim 8, where in said vent pin is disposed at an end-of-fill location of said second cavity.

14. A mold assembly for forming a trim component having a first layer and a second layer, said mold assembly comprising:
a first mold portion defining a first contour surface;
a second mold portion defining a second contour surface, said first contour surface and said second contour surface defining a first cavity for receiving a first material, said first material forming a first layer of a trim component, a surface of said first layer of said trim component and said second contour surface defining a second cavity for forming a second layer of said trim component; and
a porous vent pin mounted within a first vent aperture in said first contour surface of said first mold portion;
wherein said porous vent pin extends through said first cavity between said first contour surface and said second contour surface and engages said second contour surface, said porous vent pin defining a second vent aperture in said first layer; and
wherein said porous vent pin defines an outlet for gasses from said second cavity.

15. The mold assembly according to claim 14, further including a third mold portion defining a third contour surface, said surface of said first layer of said trim component and said third contour surface defining said second cavity.

16. The mold assembly according to claim 14, wherein said first and second vent apertures define an outlet for gas present in said second cavity during forming of said second layer of said trim component.

17. The mold assembly according to claim 14, where in said porous vent pin is disposed at an end-of-fill location of said second cavity.

18. A mold assembly for forming a trim component having a first layer and a second layer, said mold assembly comprising:
a first mold portion defining a first contour surface;
a second mold portion defining a second contour surface;
a third mold portion defining a third contour surface; said first contour surface and said second contour surface defining a first cavity for receiving a first material, said first material forming a first layer of a trim component, a surface of said first layer of said trim component and said third contour surface defining a second cavity for forming a second layer of said trim component; and
a vent pin extending outwardly of said second contour surface and engaging said first contour surface, said vent pin defining a vent aperture in said first layer.

19. The mold assembly according to claim 18, wherein said vent aperture defines an outlet for gas present in said second cavity during forming of said second layer of said trim component.

20. The mold assembly according to claim 18, where in said vent pin is disposed at an end-of-fill location of said second cavity.
